(19) United States
(12) Patent Application Publication
(10) Pub. No.: US 2022/0374188 A1
(43) Pub. Date: Nov. 24, 2022

(54) ELECTRONIC BILLBOARD AND CONTROLLING METHOD THEREOF

(71) Applicant: BENQ CORPORATION, Taipei (TW)

(72) Inventor: Po-Chun HUANG, Taipei City (TW)

(73) Assignee: BENQ CORPORATION, Taipei (TW)

(21) Appl. No.: 17/726,626

(22) Filed: Apr. 22, 2022

(30) Foreign Application Priority Data
May 19, 2021 (TW) 110118071

(51) Int. Cl. G06F 3/14; G06F 3/01; G06F 3/16; H04L 65/80; H04L 47/2416

(52) U.S. Cl. CPC G06F 3/1446; G06F 3/013; G06F 3/16; H04L 65/80; H04L 47/2416; G06F 3/017; G06F 3/0488

(57) ABSTRACT

An electronic billboard and a controlling method thereof are disclosed, wherein the electronic billboard includes plural displaying areas, a user interaction tracker and a data flow manager. Each one of the display areas correspondingly form a telecommunication connection with one of plural video delivery devices, and respectively displays the image data provided by the video delivery devices. The user interaction tracker is used to calculate the interaction indexes between at least one user and each one of the display area. The data flow manager regulates the flows of the image data respectively delivered to the display areas according to the interactive indexes.

This application claims the benefit of Taiwan application Serial No. 110118071, filed May 19, 2021, the subject matter of which is incorporated herein by reference.

### BACKGROUND

### Technical Field

The disclosure relates to a display and a controlling method thereof, and more particularly to an electronic billboard and a controlling method thereof.

### Description of Background

With the development of today's technology, various large-scale displays or screens, such as large-scale electronic billboards in the form of wall-mounted, floor-to-ceiling, screen splicing, touch display, etc., have been widely used in daily life or commercial markets. In practical applications, the screen of the large-scale electronic billboards can be divided into multiple displaying areas for playing various audio and video contents according to the needs of different industries or users.

With the substantially increased density of audio and video contents, more diversity and convenience in interacting with users can be provided, however, the data (for example, audio and video data) that the large-scale electronic billboards need to process has also increased significantly. Furthermore, since the software and hardware resources of the large-scale electronic billboards cannot be expanded synchronously in equal amounts, the overall display quality or interactive response is often degraded. How to integrate the existing software and hardware resources of the large-scale electronic billboards to provide the best display quality and real-time interactive response has become an important topic in the related technical field.

Therefore, there is a need of providing an advanced electronic billboard and a control method thereof to obviate the drawbacks encountered from the prior art.

### SUMMARY

One aspect of the present disclosure is to provide an electronic billboard, wherein the electronic billboard includes plural displaying areas, a user interaction tracker and a data flow manager. Each of the display areas correspondingly forms a telecommunication connection with one of plural video delivery devices and respectively displays one of plural sets of image data provided by the video delivery devices. The user interaction tracker is used to calculate the interaction indexes between at least one user and each one of the display areas. The data flow manager regulates the flows of the image data respectively delivered to the display areas according to the interactive indexes.

Another aspect of the present disclosure is to provide a controlling method of an electronic billboard, wherein the method comprises steps as follows: Firstly, an electronic billboard having plural displaying areas is provided, each of which correspondingly forms a telecommunication connection with one of plural video delivery devices and respectively displays one of plural sets of image data provided by the video delivery devices. A user interaction tracker is then used to calculate the interaction index between at least one user and each one of the display areas. A data flow manager is used to regulate the flows of the image data respectively delivered to the display areas according to the interactive indexes.

In accordance with the aforementioned embodiments of the present disclosure, an electronic billboard and a control method thereof are provided. The electronic billboard has plural displaying areas, each of which correspondingly forms a telecommunication connection with one of plural video delivery devices and respectively displays plural sets of image data provided by the video delivery devices. A user interaction tracker is then used to determine the degree of interaction between each one of the display areas and the user. A data flow manager is used to regulate the flows of the image data delivered to each one of the display areas according to its corresponding degree of interaction. By reducing the flows of the image data delivered to the display area with lower user interaction, the software and hardware resources consumption of the electronic billboard can be saved; meanwhile, the flow of the image data delivered to the display area with higher user interaction can be increased, so as to ensure the display area that originally allocated to the display area that attracts the most attention from the user has better dynamic image quality. The user's total visual experience and operation quality can be improved without increasing the cost of additional software and hardware.

### BRIEF DESCRIPTION OF THE DRAWINGS

The above objects and advantages of the present disclosure will become more readily apparent to those ordinarily skilled in the art after reviewing the following detailed description and accompanying drawings, in which:

FIG. 1 is a block diagram illustrating an operation system of an electronic billboard according to one embodiment of the present disclosure;

FIG. 2 is a flowchart illustrating a controlling method of the electronic billboard of FIG. 1 according to one embodiment of the present disclosure; and

FIG. 3 is a block diagram illustrating an operation system of an electronic billboard according to another embodiment of the present disclosure.

### DETAILED DESCRIPTION

The embodiments as illustrated below provide an electronic billboard and a controlling method thereof to improve user's total visual experience and operation quality without increasing the cost of additional software and hardware. The present disclosure will now be described more specifically with reference to the following embodiments illustrating the structure and arrangements thereof.

It is to be noted that the following descriptions of preferred embodiments of this disclosure are presented herein for purpose of illustration and description only. It is not intended to be exhaustive or to be limited to the precise form disclosed. Also, it is important to point out that there may be other features, elements, steps, and parameters for implementing the embodiments of the present disclosure which are not specifically illustrated. Thus, the descriptions and the drawings are to be regard as an illustrative sense rather than a restrictive sense. Various modifications and similar arrangements may be provided by the persons skilled in the art within the spirit and scope of the present disclosure. In addition, the illustrations may not be necessarily drawn to scale, and the identical elements of the embodiments are designated with the same reference numerals.

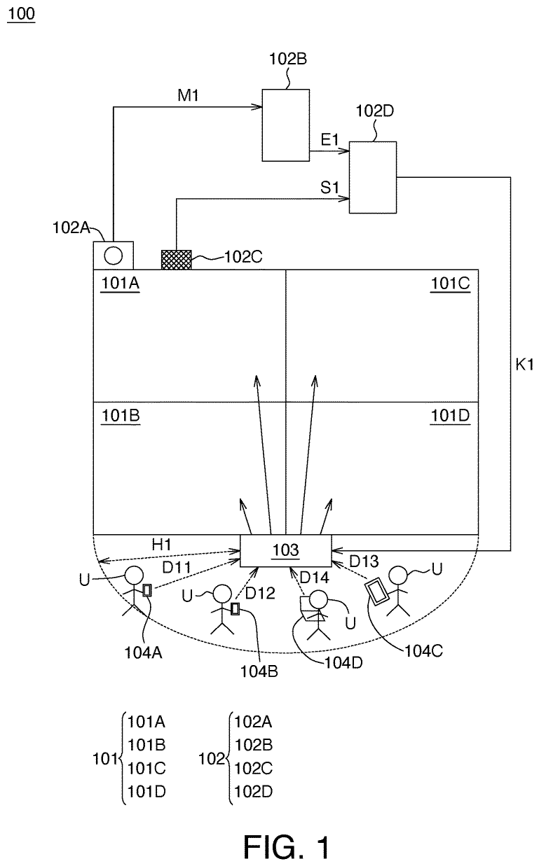

FIG. 1 is a block diagram illustrating an operation system of an electronic billboard 100 according to one embodiment of the present disclosure. The electronic billboard 100 includes a display screen 101, a user interaction tracker 102 and a data flow manager 103. Wherein, the display screen 101 can be divided into plural display areas 101A, 101B, 101C and 101D, each of which correspondingly forms a telecommunication connection with one of plural video delivery devices 104A, 104B, 104C and 104D and respectively displays plural sets of image data D11, D12, D13 and D14 correspondingly provided by the video delivery devices 104A, 104B, 104C and 104D.

In some embodiments of the present disclosure, the display screen 101 may be a flat display screen composed of a large-scale whole panel. In some other embodiments of the present disclosure, the display screen 101 may be a video wall formed by splicing a plurality of cathode ray tube (CRT) TVs. In this embodiment, the display screen 101 may be a flat display screen formed by splicing a plurality of small-sized flat display panels (not shown).

The display areas 101A, 101B, 101C and 101D can correspondingly form telecommunication connections with the video delivery devices 104A, 104B, 104C and 104D by wired or wireless network. Such that, the images (not shown) currently being displayed on the built-in screens of the video delivery devices 104A, 104B, 104C and 104D can be displayed on the corresponding display areas 101A, 101B, 101C and 101D. In the present embodiment, at least one of the video delivery devices 104A, 104B, 104C and 104D can be a portable electronic device.

For example, the video delivery devices 104A, in the present embodiment, is a mobile phone using the Android operating system; the video delivery device 104B is a mobile phone using an iPhone operating system (iPhone OS, iOS); the video delivery device 104C is a tablet computer (e.g., an I Pad); and the video delivery device 104D is a notebook computer. The commands and image data D11, D12, D13 and D14 provided to the video delivery devices 104A, 104B, 104C and 104D for displaying can be also transmitted to the corresponding display areas 101A, 101B, 101C and 101D through a wireless network (e.g., WIFI).

In addition, the display screen 101 may have a touch-sensing function. In some embodiments of the present disclosure, the display screen 101 may have a touch panel (not shown) disposed outside or inside the display areas 101A, 101B, 101C and 101D of the display screen 101. The user U can control the display areas 101A, 101B, 101C and 101D by inputting commands through the corresponding video delivery devices 104A, 104B, 104C and 104D, by clicking the menus of the video corresponding delivery devices 104A, 104B, 104C and 104D, or by directly touching the corresponding touch panels (not shown) built-in the display areas 101A, 101B, 101C and 101D to perform the operations.

The user interaction tracker 102 is used to calculate the interaction index between at least one user U and each one of the display areas 101A, 101B, 101C and 101D. For example, in some embodiments of the present disclosure, the user interaction tracker 102 may include an image capturing device 102A, an eye tracking device 102B, an audio recording device 102C, a counter 102D or the arbitrary combinations thereof.

The image capturing device 102A can be used to capture the images M1 respectively formed in front of each one of the display areas 101A, 101B, 101C and 101D for a predetermined distance H1. The eye tracking device 102B can generate the eye tracking information E1 of the user U according to the images M1. The audio recording device 102C can be used to capture the sound S1 respectively formed in front of each of the display areas 101A, 101B, 101C and 101D for the predetermined distance H1. The counter 102D, according to the eye tracking information E1 and the sound S1, can calculate the number of eye gazes of which the user U dwells his/her eye gazes on each one of the display areas 101A, 101B, 101C and 101D within a preset time interval and the accumulated dwelling time of the eye gazes; calculate the number of (audio and/or video) commands received by the display areas 101A, 101B, 101C and 101D and the accumulated durations of the commands; and output an interaction index K1 with a combined weighted values, that include the weighted values of the number of eye gazes, the eye gazes duration, the number of commands and the command duration.

For example, the image capturing device 102A may include at least one digital camera or video camera for capturing a plurality of images M1 related to the user U and the surrounding scenes respectively formed in front of the display areas 101A, 101B, 101C and 101D within the predetermined time interval. The eye tracking device 102B may include an artificial intelligence (AI) algorithm to identify the face of the user U, the movement direction and/or coordinates of the eyes by analyzing the images M1 captured by the image capturing device 102A; to obtain eye tracking and eye movement data according to the characteristic changes of the eyeball and the characteristic changes around the eyeball (for example, the dynamic iris angle changes), and then to output these eye tracking information E1. The counter 102D is used to file the data (e.g., the eye tracking information E1 and the sound S1) acquired by the eye tracking device 102B (and the audio recording device 102C) and perform a simulation to calculate the number of eye gazes of which the user U dwells his/her eye gazes on each one of the display areas 101A, 101B, 101C and 101D within a preset time interval and the accumulated dwelling time of the eye gazes; to calculate the number of (video and/or audio) commands received by the display areas 101A, 101B, 101C and 101D and the accumulated durations of the commands; and to output an interaction index K1 for each of display area 101A, 101B, 101C and 101D.

The data flow manager 103 can control the flows of the image data delivered to each one of the display areas 101A, 101B, 101C and 101D according to the corresponding interaction indexes K1 of the display areas 101A, 101B, 101C and 101D. Through the image data flow allocation and control performed by the data flow manager 103, the flow of the image data delivered to the display areas with lower interactive index K1 can be reduced, so as to save the consumption of software and hardware resources of the display screen 101. At the same time, the flow of the image data delivered to the display areas with higher interaction index K1 can be increased, so as to ensure that the display areas with higher interaction index K1 have better dynamic image quality. In some embodiments of the present disclosure, the data flow manager 103 can be selected from a group consisting of a bandwidth distributor, a hardware decoder, a software decoder and the arbitrary combinations thereof.

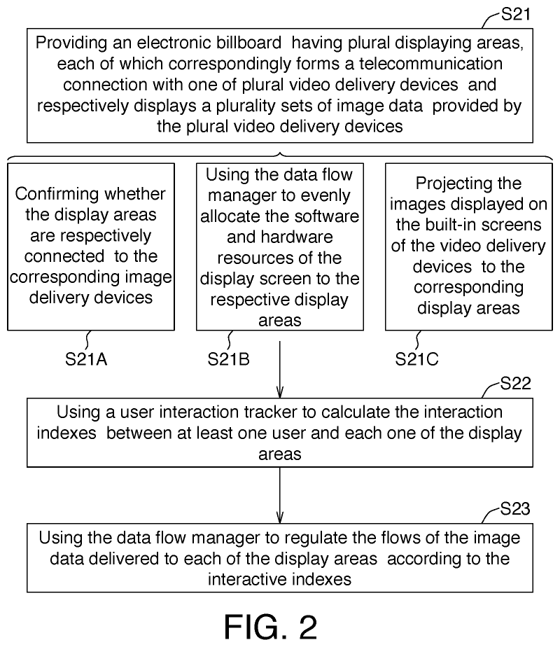

FIG. 2 is a flowchart illustrating a controlling method of the electronic billboard 100 of FIG. 1 according to one embodiment of the present disclosure. The method comprises steps as follows:

Firstly, in step S21: an electronic billboard 100 having plural displaying areas 101A, 101B, 101C and 101D is provided, each of which correspondingly forms a telecommunication connection with one of plural video delivery devices 104A, 104B, 104C and 104D and respectively displays plural sets of image data D11, D12, D13 and D14 provided by the video delivery devices 104A, 104B, 104C and 104D.

The process of providing the electronic billboard 100 includes steps of confirming whether the display areas 101A, 101B, 101C and 101D are respectively connected (e.g., through a WIFI wireless network) to the corresponding image delivery devices 104A, 104B, 104C and 104D (see step S21A); using the data flow manager 103 to evenly allocate the software and hardware resources (such as bandwidth, decoder configuration or memory capacity) of the display screen 101 to the respective display areas 101A, 101B, 101C and 101D (see step S21B); and projecting the images displayed on the built-in screens (not shown) of the video delivery devices 104A, 104B, 104C and 104D to the corresponding display areas 101A, 101B, 101C and 101D (see step S21C).

For example, in the present embodiment, the maximum bandwidth of the display screen 101 of the electronic billboard 100 is assumed to be 80 Mbps, which is evenly allocated to the display areas 101A, 101B, 101C and 101D, therefor each display area 101A, 101B, 101C and 101D can share a bandwidth of 20 Mbps (80 Mbps/4=20 Mbps).

In step S22: a user interaction tracker 102 is then used to calculate the interaction indexes K1 between at least one user U and each one of the display areas 101A, 101B, 101C and 101D. In some embodiments of the present disclosure, the interaction indexes K1 includes a combined weighted value of the number of eye gazes and the number of commands (including the number of touch-sensing commands and the number of audio commands).

The weighted value of the number of eye gazes refers to: the value of the number of eye gazes of which the user U dwells his/her eye gazes on one of the display areas 101A, 101B, 101C and 101D within a preset time interval (for example, 300 seconds) multiplied by the accumulated the dwelling time of the eye gazes. The weighted value of the number of commands refers to: the number of commands (including the commands inputted through the WIFI wireless network, the user's U finger touching on the touch panel, the audio recording device, the keypad or any other possible means) of the one the display areas 101A, 101B, 101C and 101D receive from the user U multiplied by the accumulated durations of the commands (including the accumulation time of the finger touching and/or the audio recording).

Table 1 discloses the parameters (including the number of the eye gazes, the accumulated gaze time, the number of the touch-sensing commands, the accumulated figure touch time, the number of the audio commands, and the accumulated audio recording time) used by the interaction tracker 102 for calculating the interaction index K1:

TABLE 1

| | Display | Display | Display | Display |
|---|---|---|---|---|
| | Area | Area | Area | Area |
| | 101A | 101B | 101C | 101D |
| Number of the eye gazes | 5 | 5 | 0 | 0 |
| Accumulated gaze time | 300 | 200 | 0 | 0 |
| Number of the touch- | 0 | 0 | 0 | 0 |
| sensing commands | | | | |
| accumulated figure | 0 | 0 | 0 | 0 |
| touch time | | | | |
| Number of the | 0 | 0 | 2 | 0 |
| audio commands | | | | |
| Accumulated | 0 | 0 | 30 | 0 |
| audio recording time | | | | |
| Total displaying time | 300 | 300 | 300 | 300 |
| (The preset time interval) | | | | |

In some embodiments of the present disclosure, the interaction index K1 can be the sum of the weighted value of the number of eye gazes and the weighted value of the number of the operation (touch-sensing/audio) commands. However, in some other embodiments of the present disclosure, the weighted value of the number of eye gazes and the weighted value of the number of the operation commands can be considered as two independent interaction index K1. In the present embodiment, the data flow manager 103 may comprehensively consider the weighted value of the number of eye gazes and the weighted value of the number of the operation commands, and then regulates the flow of the image data delivered to each one of the display areas 101A, 101B, 101C and 101D (see step S23).

In step S23, the data flow manager 103 is used to regulate the flow of the image data delivered to each one of the display areas 101A, 101B, 101C and 101D according to its corresponding interactive index K1. For example, in the present embodiment, the data flow manager 103 first considers the weighted value of the number of eye gazes, selects the display area (e.g., the display area 101A) with the largest weighted value of the number of eye gazes, and allocates a larger proportion flow of the image data to the selected display area. Then, the remaining flow of the image data is allocated to the remaining display areas (e.g., the display area 101B, 101C and 101D) according to the corresponding proportion of the combined weighted values of the number of eye gazes and the number of the operation commands.

In detail, in the present embodiment, the display area 101A has a weighted value of the number of eye gazes of 1500(5×300); the display area 101B has a weighted value of the number of eye gazes of 1000(5×200); and both of the display areas 101C and 101D have weighted values of the number of eye gazes of 0. It can be determined that eyes of the user U are currently focusing on the display area 101A, or that the display area 101A attracts the most attention from the user U. The data flow manager 103 allocates ⅓ of the maximum bandwidth (80 Mbps×⅓=26.66 Mbps) of the display screen 101 for delivering the image data to the display area 101A; and the remaining ⅔ of the maximum bandwidth (80 Mbpsx⅔=53.32 Mbps) of the display screen 101 is then allocated in proportion to the display areas 101B, 101C and 101D respectively, according to the corresponding interactive indexes (that is the sum of the weighted value of the number of eye gazes and the weighted value of the number of the operation commands) of the display areas 101B, 101C and 101D. If the interactive index of an individual display area (e.g., the display area 101D) is 0 (that is, the sum of the weighted value of the number of eye gazes and the weighted value of the number of the operation commands is equal to 0), then the interaction index of this display area (e.g., the display area 101D) can be set as a constant k that is equal to 1 (k=1), so as to give this display area a certain guaranteed bandwidth. The bandwidth allocation of the remaining display areas 101B, 101C and 101D can be determined by the following formulas:

The bandwidth allocated to the display area 101B=(⅔×80 Mbps)×

(5×200)/[(5×200)+(3×300)+1]=28.055 Mbps;

the bandwidth allocated to the display area 101C=(⅔×80 Mbps)×

(3×300)/[(5×200)+(3×300)+1]=25.24 Mbps; and

the bandwidth allocated to the display area 101D=(⅔×80 Mbps)×

1/[(5×200)+(3×300)+1]=0.028 Mbps.

Of note that, if the bandwidth allocated to any one of the remaining display areas 101B, 101C, and 101D is greater than the bandwidth originally allocated to the display area 101A that attracts the most attention from the user U, the bandwidth originally allocated to the display area 101A should be swapped with the largest bandwidth that is allocated to the one of the remaining display areas 101B, 101C, and 101D. For example, in the present embodiment, since the bandwidth allocated to the display area 101B is 28.055 Mbps greater than the bandwidth (26.66 Mbps) originally allocated to the display area 101A that attracts the most attention from the user U, thus the bandwidth originally allocated to the display area 101A should be swapped with the bandwidth allocated to the display area 101B, so as to make the bandwidth allocated to the display area 101A equal to 28.055 Mbps; and to make the bandwidth allocated to the display area 101B equal to 26.66 Mbps.

In addition, after a period of time (for example, 3600 seconds), the counter 102D and/or the data flow manager 103 may update the parameters and the method for calculating the above-mentioned interactive index K1 once after a time period passed by. Wherein, the time period (i.e., 3600 seconds) can be greater than the preset time interval (e.g., 300 seconds).

Through the allocation and regulation of the data flow manager 103, the flow of the image data delivered to the display areas 101B, 101C and 101D with the lower interaction index K1 can be reduced, so as to save the software and hardware resources consumed by these display areas 101B, 101C and 101D; meanwhile, the flow of image data delivered to the display area 101A with the higher interaction index K1 can be increased. In other words, through the allocation and regulation of the data flow manager 103, a higher bandwidth of the display screen 101 can be reserved for the display area (e.g., display area 101A) that attracts more attention from the user U or interacts with the user U more frequently. Since the user U's eyes may switch back and forth between different display areas, when the user U's eye gaze returns to the display area (for example, the display area 101A) that attracts more attention or interacts with the user U more frequently, the image quality of the display area 101A may not vary significantly. Such that the display area 101A of the display screen 101 that attracts more attention from the user U can have better dynamic image quality. Therefore, the overall display quality of the display screen 101 and the user's operation quality can be improved without increasing the cost of additional software and hardware.

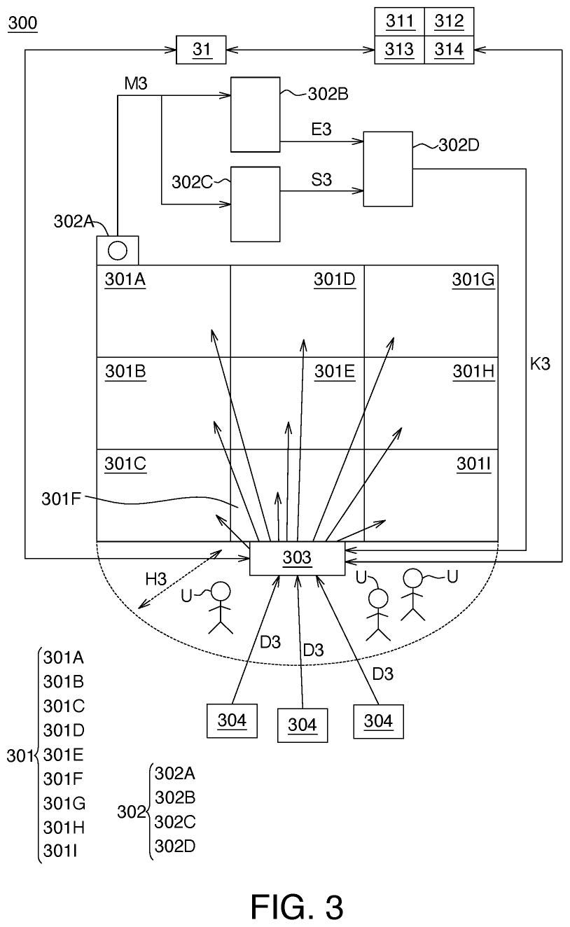

FIG. 3 is a block diagram illustrating an operation system of an electronic billboard 300 according to another embodiment of the present disclosure. The structure of the electronic billboard 300 is substantially the same that of the electronic billboard 100 depicted in FIG. 1. The difference therebetween is that the display screen 301 of the electronic billboard 300 can be divided into more display areas (such as 9 display areas 301A-301I); the parameters for calculating the interaction indexes and the method for allocating the flow of the image data are also different.

In the present embodiment, the electronic billboard 300 includes a display screen 301, a user interaction tracker 302 and a data flow manager 303. The display screen 301 can be divided into nine display areas 301A-301I, each of which correspondingly forms a telecommunication connection with one of plural video delivery devices 304 and respectively displays plural sets of image data D3 provided by the plural video delivery devices 304. The user interaction tracker 302 may include an image capturing device 302A, an eye tracking device 302B, a gesture tracking device 302C, a counter 302D or the arbitrary combinations thereof.

It should be noted that although the display screen 301 is divided into nine display areas 301A-301I, but the number of the video delivery devices 304 may not necessarily match to the display areas 301A-301I. In some embodiments of the present disclosure, the number of the video delivery devices 304 may be less than the number of the display areas 301A-301I (i.e., <9). Such that, at least one of image delivery device 304 can provide multiple sets of identical image data D3 and display them in different display areas.

The image capturing device 302A can be used to capture the images M3 respectively formed in front of each one of the display areas 301A-301I for a predetermined distance H3. The eye tracking device 302B can generate the eye tracking information E3 of the user U according to the images M3. The gesture tracking device 302C can recognize and calculate the hand instructions of the user U according to the images M3, and output the corresponding hand-gesture tracking information S3. The counter 302D, according to the eye tracking images E3 and the hand-gesture tracking information S3, can calculate the number of eye gazes of which the user U dwells his/her eye gazes on each one of the display areas 301A-301I within a preset time interval and the accumulated dwelling time of the eye gazes; calculate the number of hand instructions received by the display areas 301A-301I and the accumulated durations of the hand instructions; and output an interaction index with a combined weighted values according to these aforementioned parameters, that include the weighted value of the number of eye gazes, the eye gazes duration, the number of hand instructions and the hand instructions duration.

The data flow manager 303 can control the flow of the image data delivered to each one of the display areas 301A-301I according to the corresponding interaction indexes of the display areas 301A-301I. For example, in the present embodiment, the data flow manager 303 first considers the weighted value of the number of eye gazes, selects the display area (e.g., the display area 301A) with the largest weighted value of the number of eye gazes, and allocates a larger proportion flow of the image data to the selected display area. Then, the remaining flow of the image data is allocated to the remaining display areas (e.g., the display area 301B-301I) according to the corresponding proportion of the combined weighted values of the number of eye gazes and the number of the operation commands.

The data flow manager 303 can first allocate 2/8 (80 Mbps/8=20 Mbps) of the maximum bandwidth of the display screen 301 to the display area 301A; the remaining 6/8 of the maximum bandwidth ( 6/8×80 Mbps=60 Mbps) is then equally allocated to the remaining display areas 301B-301I, so as to make the bandwidth allocated to the display area 301A equal to 20 Mbps; and to make the bandwidth allocated to each one of the remaining display areas 301B-301I equal to 8.57 Mbps.

Through the image data flow allocation and control performed by the data flow manager 303, the flow of the image data delivered to the display areas with lower interactive index can be reduced, so as to save the consumption of software and hardware resources of the display screen 301. At the same time, the flow of the image data delivered to the display areas with higher interaction index K3 can be increased, so as to ensure that the display areas with higher interaction index K3 have better dynamic image quality. Therefore, the overall display quality of the display screen 301 and the user's operation quality can be improved without increasing the cost of additional software and hardware.

In addition, the image data needs to be decoded before it is delivered to each of the display areas 301A-301I for displaying, and the displaying quality of each display area 301A-301I may be related to the decoding method of the image data. Taking the electronic billboard 300 shown in FIG. 3 as an example, a hardware decoder executed by external display cards 311-314a each including a graphic processing unit (GPU), and a software decoder executed by the central processing unit (CPU) 31 of the electronic billboard 300 both are provided to perform the decoding process. Because, the software decoder may consume a lot of computing resources of the CPU, the processing performance of the electronic billboard 300 may be deteriorated. In addition, the external graphics cards 311-314 may not consume the computing resources of the CPU. Thus the performance of hardware decoding may be better than that of software decoding.

In the present embodiment, the data flow manager 303 may select that with the best performance from the four display cards 311-314 (e.g., the display card 311), according to the aforementioned bandwidth allocation and regulation, to decode the image data that will be delivered to the display area (for example, the display area 301A) currently attracting the most attention from the user or interacting with the user the most frequently. Thereby, the visual perception of the display area 301A and operation quality for the user U can be improved.

Subsequently, the image data that will be delivered to the 3 display areas that respectively attract the second, the third and fourth attention from the user are allocated to be decoded by the remaining display cards 312-314 respectively. The other data that will be delivered to the remaining display areas are allocated to be decoded by the CPU 31 of the electronic billboard 300.

In accordance with the aforementioned embodiments of the present disclosure, an electronic billboard and a control method thereof are provided. The electronic billboard has plural displaying areas, each of which correspondingly forms a telecommunication connection with one of plural video delivery devices and respectively displays plural sets of image data provided by the video delivery devices. A user interaction tracker is then used to determine the degree of interaction between each one of the display areas and the user. A data flow manager is used to regulate the flows of the image data delivered to each one of the display areas according to its corresponding degree of interaction. By reducing the flows of the image data delivered to the display area with lower user interaction, the software and hardware resources consumption of the electronic billboard can be saved; meanwhile, the flow of the image data delivered to the display area with higher user interaction can be increased, so as to ensure the display area that originally allocated to the display area that attracts the most attention from the user has better dynamic image quality. The user's total visual experience and operation quality can be improved without increasing the cost of additional software and hardware.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic billboard, comprising:
plural displaying areas, each of which correspondingly forms a telecommunication connection with one of plural video delivery devices and respectively displays one of plural sets of image data provided by the plural video delivery devices;
a user interaction tracker, used to calculate interaction indexes between at least one user and each one of the plural displaying areas; and
a data flow manager, used to regulate flows of the plural sets of image data respectively delivered to the plural displaying areas according to the interactive indexes.

2. The electronic billboard according to claim 1, wherein the plural video delivery devices comprise a portable electronic device.

3. The electronic billboard according to claim 1, wherein the user interaction tracker comprises:
an image capturing device, used to capture images respectively formed in front of each one of the plural displaying areas for a predetermined distance;
an eye tracking device, used to generate an eye tracking information of a user according to the images; and
a counter, used to calculate a number of eye gazes of which the user dwells his/her eye gazes on each one of the plural display areas within a preset time interval according to the eye tracking information.

4. The electronic billboard according to claim 3, wherein the counter is also used to calculate a number of commands received by each one of the plural display areas, coming from a corresponding one of the plural video delivery devices within the preset time interval.

5. The electronic billboard according to claim 4, wherein each of the interaction indexes comprises a combined weighted value including the number of eye gazes and the number of commands.

6. The electronic billboard according to claim 5, wherein the counter updates the interactive indexes once after a time period greater than the preset time interval passed by.

7. The electronic billboard according to claim 1, wherein the user interaction tracker comprises:
an image capturing device, used to capture images respectively formed in front of each one of the plural displaying areas for a predetermined distance;
a gesture tracking device, used to generate a hand-gesture tracking information of a user according to the images; and
a counter, used to calculate a number of hand instructions received by each one of the plural display areas within a preset time interval according to the hand-gesture tracking information.

8. The electronic billboard according to claim 1, wherein the user interaction tracker comprises:
an audio recording device, used to capture sound respectively formed in front of each one of the plural displaying areas for a predetermined distance;
a counter, used to calculate a number of audio commands received by each one of the plural display areas within a preset time interval according to the sound.

9. The electronic billboard according to claim 1, wherein the data flow manager is selected from a group consisting of a bandwidth distributor, a hardware decoder, a software decoder and the arbitrary combinations thereof.

10. The electronic billboard according to claim 1, wherein the data flow manager is a hardware decoder; and the data flow manager allocates the hardware decoder to decode a maximum one of the flows of the plural sets of image data.

11. An electronic billboard controlling method, comprising:
providing an electronic billboard comprising plural displaying areas, each of which correspondingly forms a telecommunication connection with one of plural video delivery devices and respectively displays plural sets of image data provided by the plural video delivery devices;
providing a user interaction tracker to calculate interaction indexes between at least one user and each one of the plural displaying areas; and
providing a data flow manager to regulate flows of the plural sets of image data respectively delivered to the plural displaying areas according to the interactive indexes.

12. The electronic billboard controlling method according to claim 11, wherein the plural video delivery devices comprise a portable electronic device.

13. The electronic billboard controlling method according to claim 11, wherein the user interaction tracker comprises:
an image capturing device, used to capture images respectively formed in front of each one of the plural displaying areas for a predetermined distance;
an eye tracking device, used to generate an eye tracking information of a user according to the images; and
a counter, used to calculate a number of eye gazes of which the user dwells his/her eye gazes on each one of the plural display areas within a preset time interval according to the eye tracking information.

14. The electronic billboard controlling method according to claim 13, wherein the counter is also used to calculate a number of commands received by each one of the plural display areas, coming from a corresponding one of the plural video delivery devices within the preset time interval.

15. The electronic billboard controlling method according to claim 14, wherein each of the interaction indexes comprises a combined weighted value including the number of eye gazes and the number of commands.

16. The electronic billboard controlling method according to claim 15, wherein the counter updates the interactive indexes once after a time period greater than the preset time interval passed by.

17. The electronic billboard controlling method according to claim 11, wherein the user interaction tracker comprises:
an image capturing device, used to capture images respectively formed in front of each one of the plural displaying areas for a predetermined distance;
a gesture tracking device, used to generate a hand-gesture tracking information of a user according to the images; and
a counter, used to calculate a number of hand instructions received by each one of the plural display areas within a preset time interval according to the hand-gesture tracking information.

18. The electronic billboard controlling method according to claim 11, wherein the user interaction tracker comprises:
an audio recording device, used to capture sound respectively formed in front of each one of the plural displaying areas for a predetermined distance;
a counter, used to calculate a number of audio commands received by each one of the plural display areas within a preset time interval according to the sound.

19. The electronic billboard controlling method according to claim 11, wherein the data flow manager is selected from a group consisting of a bandwidth distributor, a hardware decoder, a software decoder and the arbitrary combinations thereof.

20. The electronic billboard controlling method according to claim 11, wherein the data flow manager is a hardware decoder; and the data flow manager allocates the hardware decoder to decode a maximum one of the flows of the plural sets of image data.
